(19) United States
(12) Patent Application Publication
(10) Pub. No.: US 2007/0171331 A1
(43) Pub. Date: Jul. 26, 2007

(54) Liquid crystal display device and backlight module thereof

(76) Inventor: Kuan-Chang Peng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,216

(22) Filed: Jan. 16, 2007

(30) Foreign Application Priority Data
Jan. 24, 2006 (TW) 095102547

(51) Int. Cl. G02F 1/1335

(52) U.S. Cl. 349/69

(57) ABSTRACT

The present invention relates to a liquid crystal display device, and more particularly to a liquid crystal display device regards an organic electroluminescent device as a backlight module thereof. The liquid crystal display device comprises at least one first organic electroluminescent device for emitting a red light source, at least one second organic electroluminescent device for emitting a green light source, and at least one third organic electroluminescent device for emitting a blue light source disposed on a liquid crystal panel to define a plurality of pixels within which. Thus, the liquid crystal display device can achieve the purpose of full color display without disposing a color filter in which.

### FIELD OF THE INVENTION

The present invention relates to a liquid crystal display device, and more particularly to a liquid crystal display device regards an organic electroluminescent device as a backlight module thereof, such that can achieve the purpose of full color display without a color filter.

### BACKGROUND

The portable electronic equipment replaces the traditional electronic equipment with big size, since the electronic industry has developed fast. The cathode ray tube cannot be an applicable display device for the portable electronic equipment, such as a mobile phone, a personal digital assistant (PDA), and a notebook computer, so that the liquid crystal display device (LCD) has replaced the cathode ray tube (CRT), and has became a main product on the market of display device.

Referring to FIG. 1 is the prior art liquid crystal display device. The liquid crystal display device 200 comprises a backlight module 10 for emitting a white light source, and a liquid crystal panel 20 is disposed on the backlight module 10. In general, the backlight module 10 consists of a cold cathode fluorescent lamp or a light emitting diode (LED) with a light guide to generate a uniform white light source.

The liquid crystal panel 20 comprises a first polarizing filter 21, a liquid crystal layer 25, a color filter 27, and a second polarizing filter 29 attached as a stack, and the polarization direction of the first polarizing filter 21 and the second polarizing filter 29 are orthogonal. The first polarizing filter 21 linearly polarizes the white light source generated by the backlight module 10; for example, the first polarizing filter 21 filters the white light source of which polarization direction is orthogonal to the first polarizing filter 21 to generate a polarized white light source.

The controller 24 generates an electrical signal to the liquid crystal layer 25 and thereby controls the alignment direction of the liquid crystal layer 25. The liquid crystal layer 25 rotates the polarization direction of the polarized white light source passing through the liquid crystal layer 25, and then the polarized white light source rotated by the liquid crystal layer 25 is filtered by the color filter 27 to generate various color light source. For example, a single pixel comprises three sub-pixels, and a red color resist, a green color resist and a blue color resist are disposed within each sub-pixel of a signal pixel respectively. The white light source that passes through the red color resist, the green color resist, and the blue color resist will be filtered to generate a red light source, a green light source, and a blue light source respectively.

The filtered red light source, the filtered green light source, the filtered blue light source, and the polarized white light source have same polarization direction. The second polarizing filter 29 will filter partial red light source, green light source, and blue light source passing through the second polarizing filter 29 by the polarization direction of that, and the brightness of each sub-pixel within a single pixel will be related to the polarization direction of each color light source. For example, the polarized light rotated 90 degrees by the liquid crystal layer 25 can pass through the second polarizing filter 29 whose polarization direction is orthogonal to the first polarizing filter 21. The color light of the single pixel consists of the red light source, the green light source, and the blue light source of each sub-pixel within the pixel. Therefore, the full color liquid crystal display device 200 can be achieved by controlling the brightness of each sub-pixel within a pixel.

In above embodiment, the liquid crystal display device 200 is a passive matrix type display device. In another embodiment, the liquid crystal display device comprises a transparent thin film transistor array (TFT array) disposed on the liquid crystal layer 25. The controller 24 can change the alignment direction of the liquid crystal layer 25 through the TFT array, and the display quality of the liquid crystal display device can be improved. TFT array is extremely well known and needs not be further described.

The prior art liquid crystal display device 200 can achieve the purpose of full color display by using the color filter 27, but that is unfavorable to reduce the manufacturing cost of the liquid crystal display device 200. Furthermore, the color filter 27 filters partial white light source to generate the color light source, such as the red light source, the green light source, and the blue light source when the white light source passes through the color filter 27. The brightness of each color light source will decrease in the filtering process; for example the brightness of the color light source may be below 20% of the white light source. Thus, the brightness of the liquid crystal display device 200 will decrease, and the power consumed will not be reduced, and further the liquid crystal display device 200 is unfavorable to a display device of the portable electronic equipment.

### SUMMARY OF THE INVENTION

Accordingly, how to design a novel liquid crystal display device with respect to the problems encountered by the above mentioned prior art, not only reducing the cost of providing the color filter, improving the brightness of the display device, but also decreasing the power consumed in the liquid crystal display device, and it is the key point of the present invention.

It is a primary object of the present invention to provide a liquid crystal display device, which comprises an organic electroluminescent device as a backlight module for emitting a red light source, a green light source, and a blue light source to achieve the purpose of full color display without providing the color filter.

It is a secondary object of the present invention to provide a liquid crystal display device, wherein the red light source, the green light source, and the blue light source within a pixel is not a filtered light, not only improving the brightness, reducing the power consumed in the liquid crystal display device, but also increasing the suitable scope of that.

It is another object of the present invention to provide a backlight module of a liquid crystal display device, which comprises an organic electroluminescent device as the backlight module, and that is disposed on the liquid crystal panel to reduce a LED and a light guide, and the manufacturing efficiency can be improved, and further the manufacturing cost will be reduced, too.

It is another object of the present invention to provide a backlight module of a liquid crystal display device, which provides an organic electroluminescent device as the backlight module, and the thickness of the liquid crystal display device can be reduced.

It is another object of the present invention to provide a backlight module of a liquid crystal display device, which comprises an organic electroluminescent device as the backlight module, and the organic electroluminescent device can be manufactured by a semiconductor processing, and then the yield of that can be improved.

To achieve the above mentioned objects, the present invention provides a liquid crystal display device, comprising: a liquid crystal panel; and a backlight module disposed on the liquid crystal panel, comprising at least one first organic electroluminescent device for emitting a red light source, at least one second organic electroluminescent device for emitting a green light source, and at least one third organic electroluminescent device for emitting a blue light source.

Further, the present invention further provides a backlight module of a liquid crystal display device, comprising: at least one first organic electroluminescent device comprising a first electrode, a first organic light emitting layer, and a second electrode attached as a stack for emitting a red light; at least one second organic electroluminescent device comprising a first electrode, a second organic light emitting layer, and a second electrode attached as a stack for emitting a green light; and at least one third organic electroluminescent device comprising a first electrode, a third organic light emitting layer, and a second electrode attached as a stack for emitting a blue light; wherein the first organic electroluminescent device, the second organic electroluminescent device, and the third organic electroluminescent device are parallel each other.

### BRIEF DESCRIPTION OF DRAWINGS

FIG. 1 is a cross sectional view of a prior art liquid crystal display device.

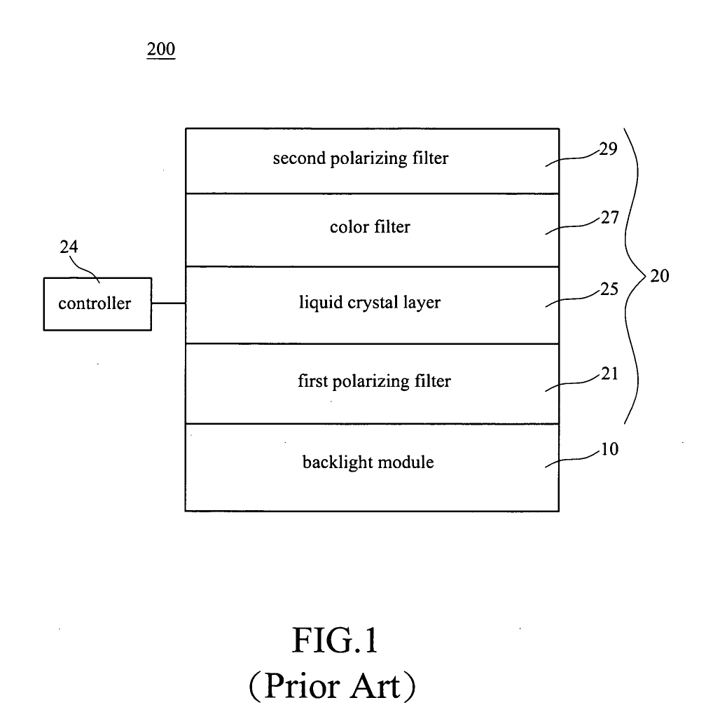

FIG. 2 is a cross sectional view of an embodiment of the present invention a liquid crystal display device.

FIG. 3 is a three-dimension view of above embodiment of the present invention.

FIG. 4 is a top view of another embodiment of the present invention.

### DETAILED DESCRIPTION

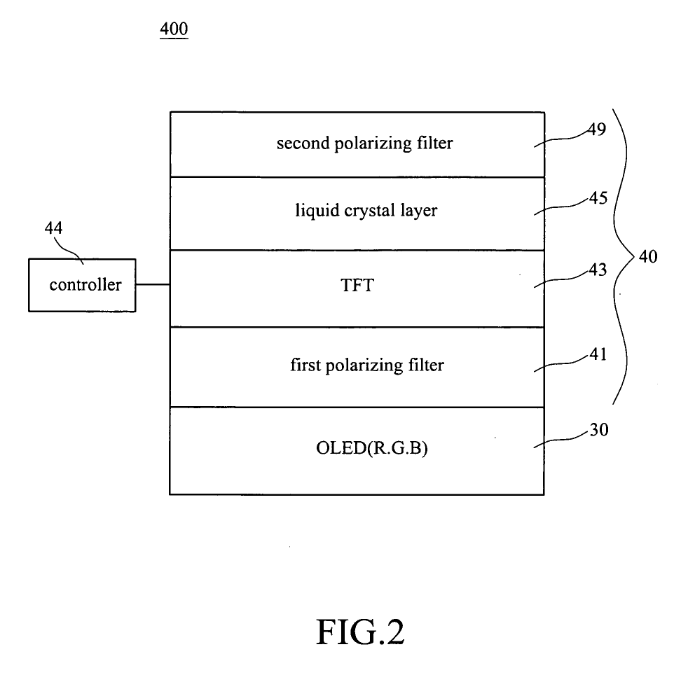

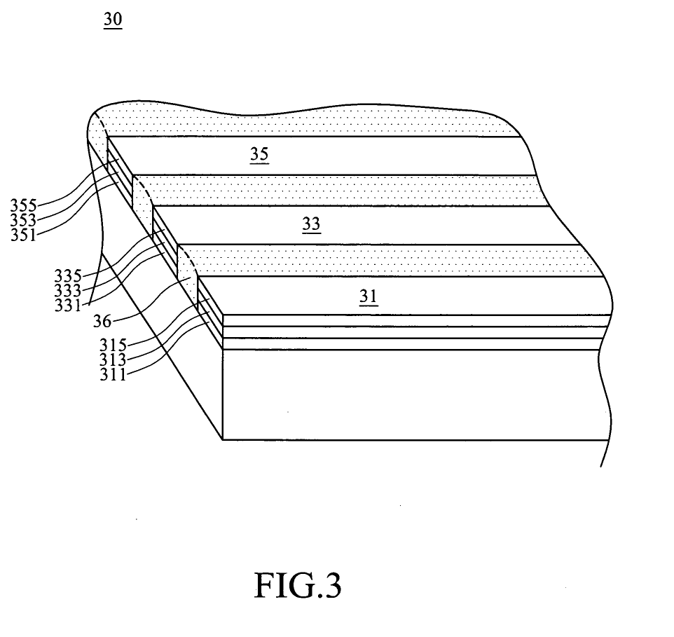

Referring to FIG. 2 and FIG. 3 are a cross section view and a three-dimension view of one embodiment of the present invention respectively. The liquid crystal display device 400 comprises at least one organic electroluminescent device 30 disposed on a liquid crystal panel 40 as a backlight module of the liquid crystal display device 400.

The liquid crystal panel 40 comprises a first polarizing filter 41, a liquid crystal layer 45, and a second polarizing filter 49. Preferably, a thin film transistor array (TFT array) 43 is disposed on the liquid crystal layer 45, so that the liquid crystal display device 400 will be a TFT liquid crystal display device. Further more, the type of the liquid crystal material within the liquid crystal layer 45 can be selected to form various liquid crystal display device, such as a TN LCD, a STN LCD, DSTN LCD, and so on.

The organic electroluminescent device 30 comprises at least one first organic electroluminescent device 31 for emitting a red light source, at least one second organic electroluminescent device 33 for emitting a green light source, and at least one third organic electroluminescent device 35 for emitting a blue light source. Furthermore, the first organic electroluminescent device 31, the second organic electroluminescent device 33, and the third organic electroluminescent device 35 are adjacent each other.

The first organic electroluminescent device 31 comprises a first electrode 311, a first organic light emitting layer 313, and a second electrode 315 attached as a stack. The second organic electroluminescent device 33 comprises a first electrode 331, a second organic light emitting layer 333, and a second electrode 335 attached as a stack. The third organic electroluminescent device 35 comprises a first electrode 351, a third organic light emitting layer 353, and a second electrode 355 attached as a stack.

The first organic light emitting layer 313, the second organic light emitting layer 333, and the third organic light emitting layer 353 are respectively an organic material for generating a red light source, a green light source, and a blue light source. When an electrical signal exists between the first electrode 311/331/351 and the second electrode 315/335/355, the first organic electroluminescent device 31, the second organic electroluminescent device 33, and the third organic electroluminescent device 35 will emit color light source (R, G, B).

The first electrode 311/331/351 can be made of same material, for example a conductive metal, and then the first electrode 311/331/351 are not only as a conductive electrode, but also as a reflector for reflecting the color light source. The second electrode 315/335/355 can be made of same material, for example a transparent conductive material, and the color light source generated by the organic light emitting layer 313/333/353 can pass through the second electrode 315/335/355.

The above-mentioned organic electroluminescent device 30 can be the backlight module of the liquid crystal display device 400 to generate a red light source, a green light source, and a blue light source stably. Therefore, the first electrode 311/331/351, the first organic light emitting layer 313, the second organic light emitting layer 333, the third organic light emitting layer 355, and the second electrode 315/335/355 of the organic electroluminescent device 30 are parallel each other.

In prior art organic electroluminescent display device, the first electrode is crisscross with the organic light emitting layer or the second electrode to define the pixel of the organic electroluminescent display device. Compared with the organic electroluminescent display device, the manufacturing process of the organic electroluminescent device 30 is easier; for example, the evaporation aligning of the first electrode 311, the first organic light emitting layer 313, and the second electrode 315 is easier, and the first organic electroluminescent device 31 can be formed with a general semiconductor processing. Of course the prior art organic electroluminescent display device can be as the backlight module of the LCD in another embodiment of the invention.

At least one insulating layer 36 as the dotted line structure of FIG. 3 can be disposed among the first organic electroluminescent device 31, the second organic electroluminescent device 33, and the third organic electroluminescent device 35 to avoid electric conduction abnormally, and benefit the flatness of the organic electroluminescent device 30.

The operation of the liquid crystal display device 400 is as follows. First, the first polarization filter 41 linearly polarizes the color light source (R, G, B) generated by the organic electroluminescent device 30, and the polarization direction of the color light source (R, G, B) that pass through the first polarizing filter 41 are same. The polarization direction of the color light source (R, G, B) will be rotated with the alignment direction of the liquid crystal layer 45 and then the rotated color light source (R, G, B) will be filtered by the second polarizing filter 49.

The polarization direction of the first polarizing filter 41 and the second polarizing filter 45 are orthogonal, so that the alignment direction of the liquid crystal layer 45 can decide the proportion of the color light source passing through the second polarizing filter 49 to control the brightness of the color light source (R, G, B). For example, the first polarizing filter 41 linear polarizes the color light source, and the liquid crystal layer 45 does not change the polarization direction of the color light source, and the polarization direction of the color light source and the second polarizing filter 49 will be perpendicular, so that the color light source cannot pass through the second polarizing filter 49. On the other hand, the first polarizing filter 41 linear polarizes the color light source, and the liquid crystal layer 45 rotates the polarization direction of the color light source to cause the polarization direction of the color light source and the second polarizing filter 49 are same, so that the color light source can completely pass through the second polarizing filter 49.

The controller 44 can change the electrical signal that inputs to the liquid crystal layer 40 or thin film transistor array 43, so that the alignment of the liquid crystal layer 40 will be changed with the electrical signal. Therefore, the controller 44 can control the brightness of the color light source (R, G, B) individually. For example, the controller 44 is electric connection with a TFT Array 43, and the controller 44 can control the alignment of the liquid crystal layer 45 by the TFT Array 43 to change the brightness of the color light source (R, G, B).

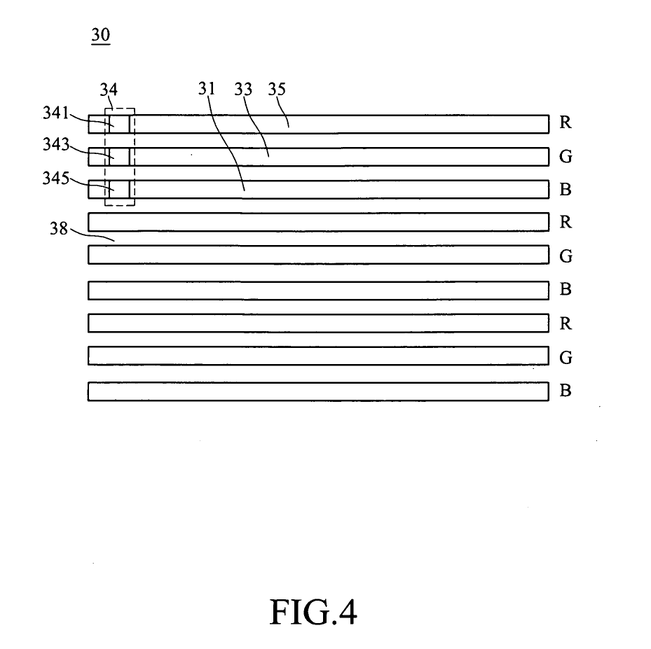

Referring to the FIG. 4 is a top view of another embodiment of the invention. As shown, the organic electroluminescent device 30 comprises at least one first organic electroluminescent device 31, at least one second organic electroluminescent device 33, and at least one third organic electroluminescent device 35 that are disposed on the liquid crystal panel 40 and parallel each other.

A gap 38 exists among the first organic electroluminescent device 31, the second organic electroluminescent device 33, and the third organic electroluminescent device 35, so that the first organic electroluminescent device 31, the second organic electroluminescent device 33, and the third organic electroluminescent device 35 can be separated. Besides, an insulating layer 36 can be disposed within the gap 38, as shown in FIG. 3. The desired size of the liquid crystal display device 400 or the number of pixels determines the number of the organic electroluminescent device 30.

The liquid crystal layer 45 of the liquid crystal panel 40 can define the display pixel of the liquid crystal display device 400; for example, the liquid crystal layer 45 disposed over the first organic electroluminescent device 31, the second organic electroluminescent device 33, and the third organic electroluminescent device 35 can define a pixel 34 that consist of a first sub-pixel 341, a second sub-pixel 343, and a third sub-pixel 345.

Each sub-pixel 341/343/345 within the pixel can emit difference brightness of the color light source individually, for example, the first sub-pixel 341 for emitting a red light source, the second sub-pixel 343 for emitting a green light source, and the third sub-pixel 345 for emitting a blue light source. The color of the light within the pixel 34 changes with the brightness of the color light source of each sub-pixel within the pixel, and then the liquid crystal display device 400 can achieve the purpose of a full color display without disposing the color filter 27.

The organic electroluminescent device 30 is a plane or a narrow strip emitting light source. Compared with the Light Emitting Diode (LED) or the cold cathode fluorescent lamp, the organic electroluminescent device 30 can be a backlight module for emitting a stable and uniform light. Besides, the organic electroluminescent device 30 does not generate high temperature in the operating process, and the problem of heat sink in the liquid crystal display device 400 can be neglect.

The foregoing description is merely one embodiment of present invention and not considered as restrictive. All equivalent variations and modifications in process, method, feature, and spirit in accordance with the appended claims may be made without in any way from the scope of the invention.

1. A liquid crystal display device, comprising:
a liquid crystal panel; and
a backlight module disposed on said liquid crystal panel, comprising at least one first organic electroluminescent device for emitting a red light source, at least one second organic electroluminescent device for emitting a green light source, and at least one third organic electroluminescent device for emitting a blue light source.

2. The liquid crystal display device of claim 1, wherein said first organic electroluminescent device, said second organic electroluminescent device and said third organic electroluminescent device are parallel each other.

3. The liquid crystal display device of claim 1, wherein said first organic electroluminescent device, said second organic electroluminescent device and said third organic electroluminescent device are adjacent.

4. The liquid crystal display device of claim 1, wherein said first organic electroluminescent device comprises a first electrode, a first organic light emitting layer and a second electrode attached as a stack; said second organic electroluminescent device comprises a first electrode, a second organic light emitting layer, and a second electrode attached as a stack; and said third organic electroluminescent device comprises a first electrode, a third organic light emitting layer and a second electrode attached as a stack.

5. The liquid crystal display device of claim 4, wherein said first electrode, said first organic light emitting layer, said second organic light emitting layer, said third organic light emitting layer, and said second electrode are parallel each other.

6. The liquid crystal display device of claim 4, wherein said first electrode is made of a conductive metal.

7. The liquid crystal display device of claim 4, wherein said second electrode is made of a transparent conductive material.

8. The liquid crystal display device of claim 1, further comprising a gap disposed among said first organic electroluminescent device, said second organic electroluminescent device, and said third organic electroluminescent device.

9. The liquid crystal display device of claim 8, further comprising a isolating layer disposed within said gap.

10. The liquid crystal display device of claim 1, wherein said liquid crystal panel comprises a first polarizing filter, a liquid crystal layer, and a second polarizing filter.

11. The liquid crystal display device of claim 10, further comprising a thin film transistor array.

12. The liquid crystal display device of claim 11, wherein said thin film transistor array connects with a controller.

13. The liquid crystal display device of claim 1, wherein said liquid crystal panel lacks a color filter.

14. A backlight module of a liquid crystal display device, comprising:
at least one first organic electroluminescent device comprising a first electrode, a first organic light emitting layer, and a second electrode attached as a stack for emitting a red light source;
at least one second organic electroluminescent device comprising a first electrode, a second organic light emitting layer, and a second electrode attached as a stack for emitting a green light source; and
at least one third organic electroluminescent device comprising a first electrode, a third organic light emitting layer, and a second electrode attached as a stack for emitting a blue light source;
wherein said first organic electroluminescent device, said second organic electroluminescent device, and said third organic electroluminescent device are parallel each other.

15. The backlight module of claim 14, wherein said backlight module is disposed on a liquid crystal panel.

16. The backlight module of claim 14, further comprising a gap disposed among said first organic electroluminescent device, said second organic electroluminescent device, and said third organic electroluminescent device.

17. The backlight module of claim 16, further comprising an isolating layer disposed within said gap.
